(19) United States
(12) Patent Application Publication
(10) Pub. No.: US 2005/0153766 A1
(43) Pub. Date: Jul. 14, 2005

(54) E-Commerce Role Playing Platform

(76) Inventor: Matthew C. Harmon, Hollywood, CA (US)

Correspondence Address: JEFFREY FURR, 253 N. MAIN STREET, JOHNSTOWN, OH, 43031, US

(21) Appl. No.: 10/907,212

(22) Filed: Mar. 24, 2005

Related U.S. Application Data
(63) Continuation-in-part of application No. 09/730,165, filed on Dec. 5, 2000.

(51) Int. Cl. G06F 19/00

(52) U.S. Cl. 463/9

(57) ABSTRACT

The current invention is an improved Interactive and multi-user role-play game that is played over a computer network, and capable of accommodating a large audience of users. The game allows users to purchase skills, levels and ideas using real currency. Specifically to provide the user with ability to set-up a “game account” which will accept deposits, enable a user to make purchases, build characters, accept winnings, and pay the opponent upon defeat. To provide the user “place” to return to and control of their game account via the PLATFORM. The PLATFORM is a “virtual storage” and/or “virtual safe deposit box” it provides the ability for the user to store and access a history of events, game statistics, tracking of game events, and account transactions.

### CROSS REFERENCE TO RELATED APPLICATIONS

This is a Continuation-in-part of application Ser. No. 09/730,165 filed Dec. 5, 2000.

### BACKGROUND OF INVENTION

1. Field of the Invention

The present invention relates to Internet game playing, more particular an role playing game where the participants can use currency for E-commerce.

2. Description of Prior Art

There are a number of role playing games currently on the market such an Ultima and Elfquest. These games allow a player to play in the role of someone in the game. Most of these games a player starts at a beginning level with limited stats and equipment and build these up by earning currency such as gold in the game and finding and buying equipment and items to make their character stronger. This can be time consuming and expensive to play long enough to allow someone to be powerful enough so that it is interesting instead on spending time killing low level creature such as rats.

There are people who will play the game and sell their higher level characters and equipment to other players for real money but this is not an integral and coordinated part of the game itself.

There exists a need to provide internet game players and other players a game or simulation that allows them to play with and for real money. There is still need for improvement in the art.

### SUMMARY OF INVENTION

The current invention is a game that users can enter/re-enter, can set up a “game account”, with a deposit of funds, or can enter in beginner mode (for a timed period with no initial deposit), but gain funds from his/her opponents to build his/her “game account”. This game account can be funded through real money depending on the game.

Additional objects and advantages are; a having PLATFORM that can be used to manage a users account, and a having PLATFORM that is designed to store the users game play tactics, a history of events, such as opponents, defeats, review game play for learning and enhancing skills.

The PLATFORM offers the user the opportunity to re-enter a game by logging-in to their existing account and resume play or joining/entering in a new game. The PLATFORM provides memory and storage, which allows the user to recall information.

Other objectives and advantages of the present invention will become obvious to the reader and it is intended that these objectives and advantages are within the scope of the present invention.

To accomplish the above and related objectives, this invention may be embodied in the form illustrated in the accompanying drawings, attention being called to the fact, however, that the drawings are illustrative only, and that changes may be made in the specific construction illustrated.

Definitions:

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Player: A person who plays the game.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Player: Same as a sports figure.

RPG: Role Playing Game.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows how a user would access the Internet system;

FIG. 2 shows how a player funds a game account;

FIG. 3 displays the password logon screen;

FIG. 4 shows how a player is cap from losing to much;

FIG. 5 displays the initial deposit to the game account; and

FIG. 6 displays the handicap system.

### DETAILED DESCRIPTION

The current invention is an E-Commerce Role Playing Platform is a fairly simple computer game format that is in the context of multi-user game play via the internet. E-Commerce Role Playing Platform revolves around two very important central components: 1) a fantasy game and 2) a player's “game account.” The fantasy game will provide a forum for interactive, competitive game play. The “game account” will accept deposits, enable a player to make purchases for character building, allowing the player to accept winnings, & pay a player's opponent upon defeat. Depending on the system, this “game account” can be funded with real money so that the players play for real money. A player funding his or her account through a credit card or cash.

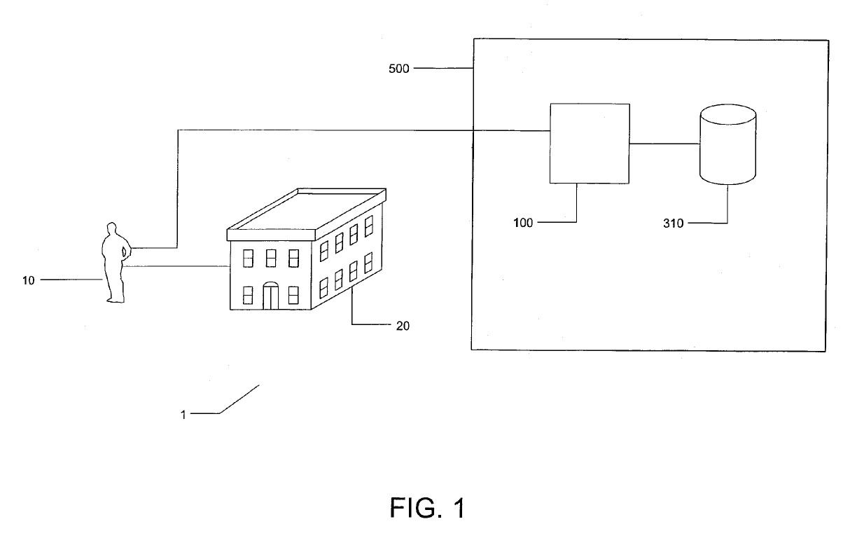

FIG. 1 illustrates a functional diagram of a computer network for World Wide Web 500 access to the System 1 which runs the game 2 from a plurality of Players 10 who access the system Web Site 100 or the Players 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon.

The Players 10 contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000 or Linux, running a Web browser. The exact hardware configuration of computer used by the Players 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Players 10 connect to the System Web Site 100. In the preferred embodiment the system has numerous web pages. The information in the web pages are in HTML format via the HyperText Transport Protocol (http) and on Server System 310. The Player System 110 includes software to allow viewing of web pages, commonly referred to as a Web Browser, such as Communicator available from Netscape Communications Corp. or Internet Explorer available from Microsoft Corp. The user system is capable of accessing web pages located on Server System 310.

Output can include a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The data processing system 1 allows for secure input, data transfer and storage of a wide array of information. The system 1 allows and handles the direct transfer of security rights for the players 10. The input, data exchange and storage of the data is achieved by electronic data transmission, thus eliminating the need for paper logs. In a first embodiment of the invention, as further discussed below, means for processing data is provided which includes computer software installed at various locations within the data processing system. In a second embodiment of the invention, the data processing system has means for processing data which is installed on a web server computer; therefore, there is but one necessary installation of the means for processing data, and users log on to a website and conduct functions within the data processing system through the web server. The first embodiment can also be referred to as a Windows.™. Version, and the second embodiment can be referred to as a web browser version. The functionality of both embodiments is essentially the same; however, the second embodiment or the web browser version may incorporate some additional enhancements, as further discussed below. The data processing system in both embodiments utilizes a secure environment to transmit all data through encryption/decryption. The data processing system further provides for an audit trail of modifications made to the recorded data.

The data processing system 1 for both embodiments includes computer processing means for processing data, storage means for storing data on a storage medium, and communication means for transferring data in a secure environment.

For the first embodiment on the Windows.™. Version, the data is entered on remote work stations and stored in local databases until the user performs a data transmission function which electronically transfers the data to a central database. The central database acts as a central repository enabling multiple off-site users to view and/or modify data, and generate reports or output.

For the second embodiment or the web browser version, it can be conceptually broken down into two main components or groupings that allow the data processing system to achieve its functionality. They are as follows: (1) a main database that acts as the central repository for data entered into the system and (2) a means for processing data or computer software means in the form of coded computer instructions.

For the web browser version, it is unnecessary to have the different installations of the computer software because the web server computer has the entire means for processing loaded thereon. The user in the web browser version logs on to the website and then performs desired functions based upon functions made available to the type of user. There are two ways in which data is entered through the browser version: (1) through a website and transmitted via a LAN or the worldwide web to the web server. The web server then forwards the data to the database; or (2) through a data feed from a separate third party electronic online trading system and transmitted via a LAN or the worldwide web to the web server or an FTP server. The web server or FTP server then forwards the data to the main database. Transmission of data in the second embodiment via the worldwide web or LAN is also secure utilizing data encryption/decryption provided by SSL. Other than consolidation of the means for processing data at the web server computer, and the manner in which data is entered and retrieved through a website, the first and second embodiments have the same functionality, except for those additional features discussed below with respect to the second embodiment.

The game 1 can be written in any industry standard language and work on any industry standard operating system and platform.

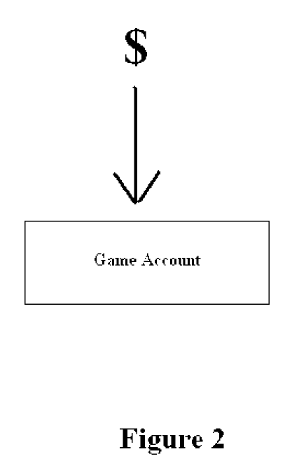

As shown in FIG. 1, the current invention is an E-Commerce Role Playing Platform is a computer game format played on a computer that is in the context of multi-user game play via the internet 500. E-Commerce Role Playing Platform revolves around two very important central components: 1) a fantasy game and 2) a player's “game account.” The fantasy game will provide a forum for interactive, competitive game play. The “game account” will accept deposits, enable a player to make purchases for character building, allowing the player to accept winnings, & pay a player's opponent upon defeat. This can be funded using real money via credit cards, cash transfers or gift cards as shown in FIG. 2.

The E-Commerce Role Playing Platform concept runs solely via the Internet 500. Like many other online, multi-user formats, it will operate through players being connected on a game server over the internet, with the licensing company serving as the game overseer and Game operating as a third party service & maintenance provider.

Technically, the specific fantasy game that a licensing company chooses to apply the E-Commerce Role Playing Platform to will be programmed sufficiently to accept a large number of users at various levels of game play, allowing them interactive competition between players. The licensing company will be responsible for the creation of the fantasy game, the server upon which their game will operate, and the correct application of the E-Commerce Role Playing format to their particular game.

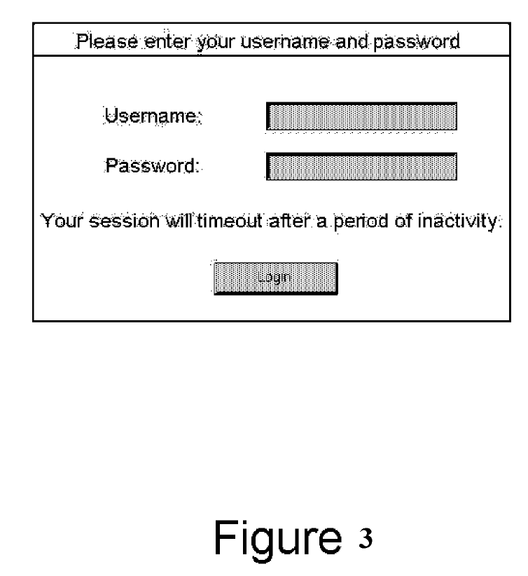

The game 1 will provide both a generic “game account” that can be customized for the licensing company and a merchant account that accepts payment for “game account” deposits/pay-outs. It will also provide, inclusive with the licensing of the E-Commerce Role Playing Platform, a forum for a user to access his/her “game account”, add additional fund to it, use it to purchase additional characteristics, view a transaction history for gains/losses and purchases/deposits made, & a format for cashing out the “game account.” All of these features will be completely customizable for the licensing company to incorporate into their user-interface. The licensing company will include with a player's “game account” the ability to save a player's character in a password=protected account even after the player has cashed out and ended his/her game play. This will enable a player to re-enter his/her game at a later date, upon deposit of required funds into the “game account,” and resume his/her game play at the level he/she exited the previous game. The password logon screen is shown in FIG. 3.

In the preferred embodiment, the E-Commerce Role Playing Platform will require, upon initial entrance to the game, parental approval from players under the age of 18 yrs. old and accepting of the terms & licensing agreements of the E-Commerce Role Playing Platform and the company that licenses it. The game 1 may conduct random checks via phone, e-mail, and mail to verify age and consent.

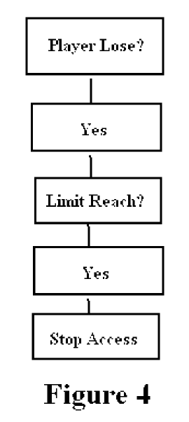

The game 1, may provide, via the “game account”, a safety net for maximum amount of loss in a given time period, based on skill level, game level, & amount of funds in the “game account.” This is shown in FIG. 4, once the player loses a maximum amount that player no longer allowed access to his or her game account.

The object of this type of game play is to begin with a fantasy computer game, along the lines of a Dungeons & Dragons™ or RPG format, using a set dollar amount to enter the initial game play. Ultimately, using additional monetary contributions to a player's “game account,” the player's goal is to beat out his opponents and win the money that is held in their “game accounts.”

Operation:

User 10 game play actually starts with the creation of and an initial deposit of funds into a player's “game account.” In the preferred embodiment, there is a beginner mode that can scale into the various levels of game play, which requires no initial deposit to the “game account” and a user 10 can simply access his/her “game account” for the gaining of funds from opponents.

The initial deposit (via e-check, credit card, or internet dollars) will allow a player to a) activate a “game account” that will ultimately accept his/her winnings from other players and pay opponents that he/she loses against, b) choose a character, c) give his/her character a basic weapon for defense and battle, and d) the ability to buy additional lives, weapons, and added features as he/she continues in their game experience. The “game account” will be the basis of a player's entrance into the interactive, multi-user game play. This is a major change over current art as a User 10 is using real currency.

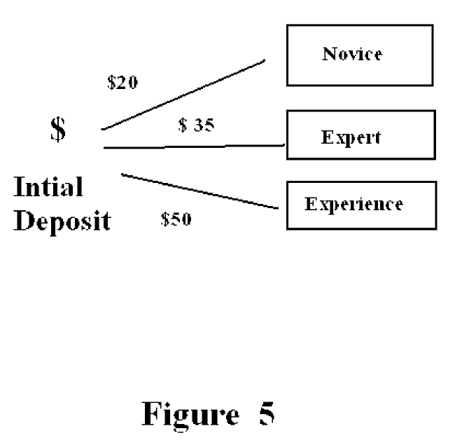

As shown in FIG. 5, the initial deposit will be made at four levels, rising in monetary value based on the skill level that a player wishes to enter the game play. For example, a $20 “game account” deposit might be required for entrance as a novice player, a $35 “game account” deposit for entrance as an experienced player, a $50 “game account deposit for entrance as an expert player. Gaining access to these levels is not limited to making these deposits, as a player can enter the game under novice status and, through successful game play, become an expert player.

Once an initial deposit has been made and a “game account” has been established, the player chooses a character that will serve as his tool to defeat his opponents throughout the levels of game play. The characters that are initially available to a user are very basic and their weaponry is extremely limited. In order for a player to progress his/her character's abilities, defense, energy, & special skills, he/she has three options:

A player can purchase additional lives, weapons, energy, & special skills via his/her “game account.”

A player can beat out his opponents and take over any additional characteristics that his opponent had gained

A player can use the “gold” (money) from his defeated opponents' “game account” to purchase additional characteristics

In the preferred embodiment, a player cannot use his/her “game account” to defeat levels of game play. The “game account” is held for purchase of additional characteristics for a player's character or for paying a successful opponent. A player can utilize purchased characteristics to help defeat opponents, and, therefore, levels—thus progressing in his game; however, there is no way to directly purchase progression through levels in the game.

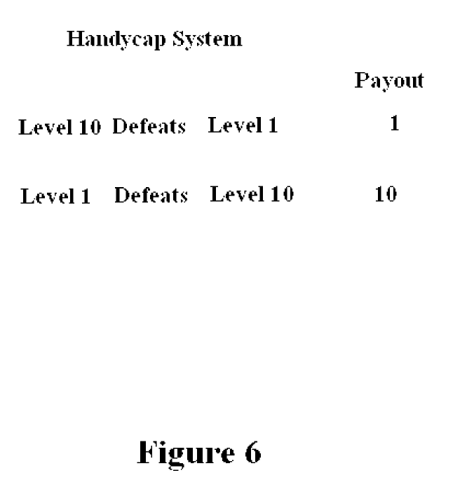

In one embodiment of the game 1, when a player 10 dual another player at a different level the amount that the winner receives is handicapped by the difference in levels. As shown in FIG. 6, the payout for a level 10 defeating a level 1 is 1 but the payout for a level 1 beating a level 10 is 10.

A player is never required to add money to his/her “game account”, after the initial deposit, if a player 10 so chooses, since all of the advantages that are available for purchase can also be garnered from accurate and successful game play.

E-Commerce Role Playing Platform creates revenue for a company that runs and maintains the game 1 by taking a percentage of the initial deposit, purchase of additional characteristics, & any profits made through successful game play. For example, the game will take a small percentage of Player A's initial “game account” deposit for operating costs and game maintenance (as well as profit). Likewise, if Player A chooses to purchase an upgrade from basic weaponry to medium level weaponry, the game will take those fees from his/her “game account” automatically. And, lastly, if Player A defeats Player B and, consequently, the gold from Player B's “game account” is transferred into his/her “game account”, the licensing company will take a small percentage of those winnings to contribute to its revenue.

Ultimately, the level of winning that a player wishes to achieve can vary substantially based on how far and for how long a player is willing to engage in game play.

A player has a number of options for removing him/herself from the game in a successful manner.

A player can reach his/her desired level and choose not to continue game play, at which point, the player can opt to cash out his/her “game account”, with a small percentage of the “game account” funds returning to the game.

A player can defeat opponents and complete a level, moving from, for instance, a novice player to an experienced player or from an experienced player to an advanced player. At this point, the player can choose to continue the game play in his/her newly acquired game level or he/she can opt to cash out his/her “game account”, with a small percentage returning to the licensing company.

A player 10 can succeed in all levels of game play, defeating the highest ranked player at the expert level, at which point he/she can opt to become a “game master” and keep the funds in his/her “game account” intact. Or the player may defeat the highest ranked player at the expert level and choose to move onto the professional level that moves all of a player's “game account” funds into a “professional game account.” This account is held in trust as a player maneuvers through the professional competition that will be completed in cycles of six months. Should a player be the ultimate winner of a six month cycle of professional level game play, he/she will receive all of the winnings from his/her opponents' “professional game accounts,” and, also, the licensing company will be responsible to add a 25% contribution to those winnings as a bonus for being an ultimate professional player in a six month cycle. It is only possible for a player to win the six month professional cycle once every two cycles. Should a licensing company agree to continue with the process, they have the option to hold yearly competitions between the two winners of the six month cycles for a monetary sum/prize determined by the licensing company.

Alternative Embodiment

In an alternative embodiment, when a player is offline, he/she has two options for his/her character. A character will have the ability to “camp” free of charge with minimal safety. But the possibility of the character being attacked by an opponent is in existence. For a minimal fee, a character can be camped on a daily basis with maximum protection and there is no possibility for attack by opponents, while offline. There will also be an “emergency camp” button for quick shut down of game play.

Advantages:

The E-Commerce Role Playing Platform will be applicable to any number of already designed fantasy games and any new fantasy games that will be developed specifically for the E-Commerce Role Playing Platform. It will appeal to all ages that wish to engage in continued interactive, progressive fantasy game play. The concept that fuels the E-Commerce Role Playing Platform is designed to compliment intelligent game playing, foster creative/imaginative virtual experience, & encourage interactive, non-aggressive competition between players from around the world. It allows a player to use real currency within the game itself to improve his or her equipment, stats and training.

Conclussion, Ramifications, & Scope

The E-Commerce Role Playing Platform provides a forum of game playing that has yet to be broached by the video game or internet industries. Not only will this format of game play appeal to players of all ages, races, & sexes, it will single-handedly provide a forum for interactive, non-aggressive game play for members of the game playing community. The platform has the potential for wide-scale distribution to numerous companies with the ability to give the public new material in a highly competitive genre. This format can be used to propagate imagination, encourage intelligent spending habits via player maintenance of the “game account,” & generate revenue for companies while simultaneously contributing to the positive connection of people around the world. The market for the E-Commerce Role Playing Platform is universal and can be translated into any number of languages for the entertainment and the development of non-aggressive competition in other countries.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A role playing strategy computer game comprising:
a multi-user game where a player plays as a role playing character where a plurality of players can play, where said game is run on a computer where said players are connected to said game through a connection to the Internet where each player has a game account that is stored in a memory means and said game account is funded with currency.

2. A game according to claim 1 further comprising said currency being a real monetary value.

3. A game according to claim 1 further comprising said game account storing a history of events, game play tactics, win record and transactions.

4. A game according to claim 1 further comprising where said game account can be used to purchase additional items.

5. A game according to claim 1 further comprising where said game account can be used to purchase additional skills.

6. A game according to claim 1 further comprising where said game account can be used to purchase additional levels.

7. A game according to claim 1 further comprising where said game account can be used to purchase special skills.

8. A game according to claim 1 further comprising where said game account can be used to purchase additional lives.

9. A game according to claim 1 further comprising where when a player beats an opponent said player takes over any additional characteristics that his opponent had gained.

10. A game according to claim 1 further comprising where a player receives currency from his defeated opponents' game account.

11. A game according to claim 10 further comprising where said currency goes to the player's game account.

12. A game according to claim 1 further comprising where said game account is funded through a credit card.

13. A game according to claim 1 further comprising where said game account is funded through cash.

14. A game according to claim 1 further comprising where said game account is funded through a check.

15. A game according to claim 1 further comprising where said game verifies a player's age.

16. A game according to claim 1 further comprising where said player is offline for a minimal fee said player will be camped on a daily basis with maximum protection.

17. A game according to claim 1 further comprising where said player is allowed to play another player where the winner wins currency from the loser's game account.

18. A game according to claim 17 further comprising where said winner is paid based on a handicap system.

19. A game according to claim 1 further comprising where a player defeats the highest ranked player at the expert level that player can opt to become a game master.

20. A game according to claim 1 further comprising where a player becomes a higher level said game will allow said player to play at a tournament level.
